(19) United States
(12) Patent Application Publication
(10) Pub. No.: US 2012/0213861 A1
(43) Pub. Date: Aug. 23, 2012

(54) 2-CHLOROPENTAFLUOROPROPENE COMPOSITIONS AND METHOD OF USE FOR EXTERMINATION OF RODENTIA

(75) Inventors: Andrew Joseph Poss, Kenmore, NY (US); Rajiv Ratna Singh, Getzville, NY (US); David Nalewajek, West Seneca, NY (US); Cheryl Cantlon, Clarence Center, NY (US)

(73) Assignee: HONEYWELL INTERNATIONAL INC., Morristown, NJ (US)

(21) Appl. No.: 13/032,039

(22) Filed: Feb. 22, 2011

(51) Int. Cl. A01N 29/02; A01P 11/00; A01N 33/18; A01N 31/02; A01N 59/26

(52) U.S. Cl. 424/601; 514/744; 514/706; 514/740

(57) ABSTRACT

Rodenticide compositions that include 2-chloropentafluoropropene, and methods of using such rodenticide compositions, are provided. The rodenticide compositions can be used as fumigants in space fumigation applications. In some examples, the rodenticide compositions can be used as drop-in replacements for methyl bromide in existing rodenticide compositions and methods of exterminating rodents using methyl bromide.

### FIELD OF THE INVENTION

The present technology relates to rodenticide compositions and methods of using rodenticide compositions to exterminate animals of the group rodentia.

### DESCRIPTION OF RELATED ART

Methyl bromide (CH₃Br) is the most widely used and most universal fumigant in the world. It is used extensively for soil fumigation, as a commodity quarantine treatment (export and imports), to control a variety of pests on numerous crops, and as a structural fumigant for wood destroying pests.

According to the Montreal Protocol of 1992, methyl bromide was categorized as an ozone depleting chemical with an ozone depleting potential (ODP) of greater than 0.2 compared to trichlorofluoromethane (CFC-11), a refrigerant used as a reference gas having an ODP of 1. Compounds that contain chlorine or bromine are capable of the destruction of the earth's protective ozone layer.

The global warming potential (GWP) is the relative ability of a chemical to cause global warming on a per-pound-released basis. Halons, including methyl bromide, have both high ODP and GWP values, which makes them serious environmental threats. Tapscott in U.S. Pat. No. 5,759,430 teaches that the presence of a carbon-carbon double bond in the molecule affords a chromophoric group which can be easily photolyzed in the troposphere.

Subsequent to the Montreal Protocol, the production levels of methyl bromide were frozen at the 1991 production levels. Methyl bromide was targeted for a 5-year phase out by the year 2005 in accordance with the Montreal Protocol. In 2005, 9575 metric tons of methyl bromide was allocated for critical uses. The large volume of critical use exemptions is due to the fact that there is no drop-in replacement to methyl bromide. A drop-in replacement means that methodology, equipment, production system, etc., do not have to be changed significantly and that a comparable amount of material can be used for the same target. That is, the alternative material is applied at nearly the same rate and with the same equipment as methyl bromide. All the current methyl bromide alternatives (such as 1,3-dichloropropene, chloropicrin, metham sodium, and methyl iodide) do not function as drop-in replacements based on physical handling requirements, performance or economics. These alternatives are commonly applied as mixtures of two or more of the individual compounds in order to attempt to produce a broader spectrum product similar to methyl bromide.

### SUMMARY OF THE INVENTION

The present technology relates to rodenticide compositions that include 2-chloropentafluoropropene, and methods of using such rodenticide compositions.

In one aspect, a rodenticide composition is provided that includes 2-chloropentafluoropropene and at least one second component. The at least one second component can be selected from the group consisting of a solvent, another active ingredient, and combinations thereof.

In another aspect, a method of exterminating rodents using a rodenticide composition is provided. The method can include the steps of: preparing a gaseous rodenticide composition comprising 2-chloropentafluoropropene; providing the gaseous rodenticide composition to a space in which at least one rodent is present; and contacting the at least one rodent with the gaseous rodenticide composition.

### BRIEF DESCRIPTION OF THE DRAWINGS

Specific examples have been chosen for purposes of illustration and description, and are shown in the accompanying drawings, forming a part of the specification.

FIG. 1 shows a comparative vapor pressure versus temperature curves for 2-chloropentafluoropropene and methyl bromide.

### DETAILED DESCRIPTION

Animals of the order rodentia are commonly referred to as rodents. The name Rodentia is derived from the Latin verb rodere, meaning “to gnaw,” and rodents have been known to gnaw through pipes, metal-sheathed cables, insulated electrical wiring, plastics, hardwoods, and many other commonly used building materials, causing major amounts of damage each year. Rodents also cause large amounts of food loss, consuming and damaging food supplies in fields, granaries, stores, and domestic properties. There are approximately 1,500 species of rodents. The most common examples of rodents that are often considered to be pests include mice and rats.

The compositions can be used as rodenticides in methods of exterminating rodents. Compositions of the present technology include chloropentafluoropropene, particularly 2-chloro-1,1,3,3,3-pentafluoropropene, which is also known as CFO-1215xc and 2-chloropentafluoropropene.

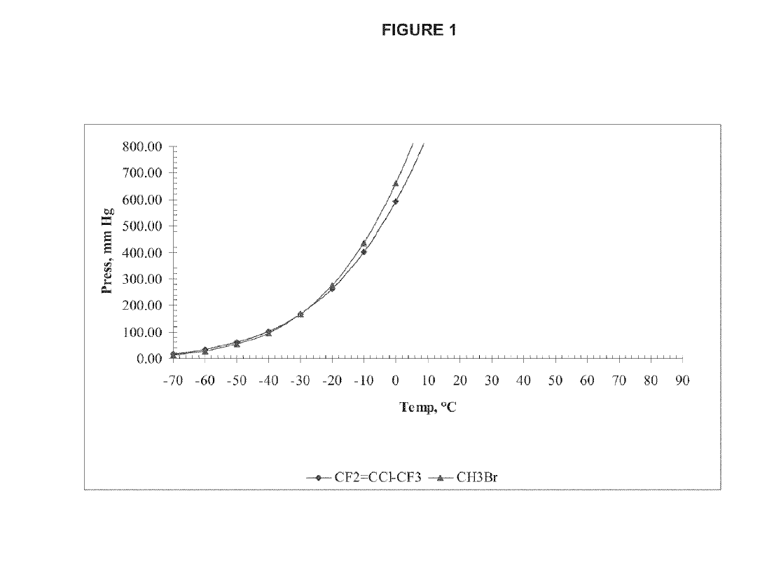

In some examples, rodenticide compositions of the present technology can be used as drop-in replacements for methyl bromide rodenticides. Advantageously, 2-chloropentafluoropropene has physical properties comparable to methyl bromine. For example, the boiling point of 2-chloropentafluoropropene is about 6.8° C. and its melting point is about −130° C., while the boiling point of methyl bromide is about 4° C. and its melting point is about −94° C. The comparative vapor pressure versus temperature curves of 2-chloropentafluoropropene and methyl bromide shown in FIG. 1 indicate that 2-chloropentafluoropropene is a gas at room temperature, and it could be applied as a liquefied gas in the same manner as methyl bromide. However, unlike methyl bromide, 2-chloropentafluoropropene does not deplete the ozone layers and it has very low global warming potential (GWP) because it has a very short atmospheric lifetime. Accordingly, at least some 2-chloropentafluoropropene containing compositions can be excellent drop-in replacements for methyl bromide in rodent extermination applications.

In some examples, rodenticide compositions can include mixtures of 2-chloropentafluoropropene and at least one second component. The at least one second component can be selected from the group consisting of a solvent, an additional active ingredient, and combinations thereof.

In examples where the rodenticide composition includes at least one solvent, the at least one solvent can be, for example, 2,3,3,3-tetrafluoropropene (CH₂═CFCF₃), also known as HFO-1234yf or simply 1234yf; trans-1,1,1,3-tetrafluoropropene, also known as HFO-1234ze or simply 1234ze; cis-1-chloro-3,3,3-trifluoropropene, also known as cis-HCFO-1233zd or simply cis-1233zd; trans-1-chloro-3,3,3-trifluoropropene, also known as trans-HCFO-1233zd or simply trans-1233zd; or a combination thereof. Rodenticide compositions of the present technology can include 2-chloropentafluoropropene in an amount from about 10% by weight of the composition to about 90% by weight of the composition, and the at least one solvent in an amount from about 90% by weight of the composition to about 10% by weight of the composition. In some examples, the amount of 2-chloropentafluoropropene is greater than the amount of the at least one solvent. In such examples, rodenticide compositions can include 2-chloropentafluoropropene in an amount from about 90% by weight of the composition to about 51% by weight of the composition, including but not limited to about 90% by weight of the composition, about 85% by weight of the composition, about 80% by weight of the composition, about 75% by weight of the composition, about 70% by weight of the composition, about 65% by weight of the composition, about 60% by weight of the composition, or about 55% by weight of the composition. Likewise, in such examples, rodenticide compositions can include the at least one solvent in an amount from about 10% by weight of the composition to about 49% by weight of the composition, including but not limited to about 12% by weight of the composition, about 15% by weight of the composition, about 20% by weight of the composition, about 25% by weight of the composition, about 30% by weight of the composition, about 35% by weight of the composition, about 40% by weight of the composition, or about 45% by weight of the composition. In some examples, the mixture of 2-chloropentafluoropropene and the at least one solvent may form an azeotropic or azeotrope-like composition.

In examples where the rodenticide compositions include mixtures of 2-chloropentafluoropropene and at least one additional active ingredient, the at least one additional active ingredient can include, but is not limited to, carbon disulfide, aluminum phosphide, magnesium phosphide, sulfuryl fluoride or chloropicrin. Such rodenticide compositions may or may not include at least one solvent as discussed above. In some examples, rodenticide compositions of the present technology can include amounts of at least one other active ingredient that are comparable to those currently employed with methyl bromide. For example, a rodenticide compositions of the present technology can include at least one other active ingredient in an amount up to about 33% by weight of the rodenticide composition, such as from about 2% by weight of the by weight of the rodenticide to about 33% by weight of the rodenticide composition. At low levels, the at least one other active ingredient, such as chloropicrin, can act as a warning agent for anyone working with a rodenticide composition of the present technology, since the 2-chloropentafluoropropene is a highly toxic odorless chemical.

Rodenticide compositions of the present technology can be used as fumigants in space fumigation applications. Space fumigation can include, for example, chamber and vault fumigation, vacuum chamber fumigation, vehicle fumigation, tarpaulin fumigation, spot fumigation, structural fumigation, empty building fumigation, shipboard fumigation, farm grain storage fumigation, rodent burrow fumigation, and fumigation of beehives, supers and other beekeeping equipment. Due to the toxicity of the rodenticide compositions, spaces to be fumigated can be sealed, and are preferably rendered as air tight as practically possible prior to fumigation.

Methods of using rodenticide compositions of the present technology can include preparing a gaseous rodenticide composition, providing the gaseous rodenticide composition to a space in which at least one rodent is present, and contacting the at least one rodent with the gaseous rodenticide composition.

Preparing the gaseous rodenticide composition can include combining the 2-chloropentafluoropropene with at least one second component to form a rodenticide composition of the present technology. As discussed above, the at least one second component can be a solvent, an additional active ingredient, or a combination thereof. The combining can be carried out at a temperature at or above the boiling point of the rodenticide composition. Alternatively, the combining can be carried out as a temperature below the boiling point of the rodenticide composition, and the rodenticide composition can then be heated to a temperature at or above the boiling point of the rodenticide composition to form the gaseous rodenticide composition.

Providing the gaseous rodenticide composition to a space in which at least one rodent is present can be carried out in any suitable manner. In examples where the rodenticide compositions of the present technology can be used as drop-in replacements for methyl bromide, the step of providing the gaseous rodenticide composition to a space in which at least one rodent is present can be carried out using equipment that was originally designed to provide gaseous methyl bromide compositions.

The step of providing the gaseous rodenticide composition to a space in which at least one rodent is present can be carried out at any suitable environmental temperature, the environmental temperature being the temperature of the air in the space in which at the least one rodent is present. For example, the environmental temperature is preferably at or above the boiling point of the rodenticide composition. In some examples, the environmental temperature can be from about 10° C. to about 30° C., including from about 15° C. to about 27° C. In examples where rodenticide compositions of the present technology are a gas at room temperature, they can be packaged in cylinders as a liquid under pressure and then volatilize rapidly upon release from the cylinder. An auxiliary heat source can be used to heat the rodenticide composition to insure that it is vaporized so that the gaseous rodenticide composition can be provided to a space in which at least one rodent is present. The gaseous rodenticide can be released under its own vapor pressure through tubing directly in to the space in which at least one rodent is present. In some examples, fans can be used with the space to distribute the gaseous rodenticide throughout the fumigation area.

When the gaseous rodenticide composition is provided to a space in which at least one rodent is present, contact between the at least one rodent and the gaseous rodenticide composition can result in the rodent being exposed to a lethal amount of the gaseous rodenticide composition. Without being bound by any particular theory, it is believed that lethal exposure to the rodenticide compositions can be achieved through inhalation of the gaseous rodenticide composition by a rodent. The exposure period that provides rodents with a lethal amount of contact with the gaseous rodenticide composition can vary. For example, the gaseous rodenticide composition can be applied to a tarped or sealed structure for an exposure period of from about 2 hours to about 72 hours, including but not limited to from about 20 hours to about 24 hours. An aeration period can used following an exposure period, which can be from about 6 hours to about 8 hours. The dosages of a gaseous rodenticide composition that can be applied during an exposure period can vary, depending upon such factors as that type of structure, the environmental, the length of the exposure period, and the rate the fumigant is lost from the structure. In some examples, such as dry wood home fumigations, the dosage of gaseous rodenticide composition can be from about 0.05 pounds per thousand cubic feet to about 1.0 pound per thousand cubic feet.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A method of exterminating rodents using a rodenticide composition, the method comprising the steps of:
preparing a gaseous rodenticide composition comprising 2-chloropentafluoropropene;
providing the gaseous rodenticide composition to a space in which at least one rodent is present; and
contacting the at least one rodent with the gaseous rodenticide composition.

2. The method of claim 1, wherein the gaseous rodenticide composition comprises 2-chloropentafluoropropene in an amount from about 10% by weight of the composition to about 90% by weight of the composition.

3. The method of claim 1, wherein the gaseous rodenticide composition comprises 2-chloropentafluoropropene and at least one solvent.

4. The method of claim 3, wherein the at least one solvent is selected from the group consisting of HFO-1234yf, HFO-1234ze, cis-HCFO-1233zd, trans-HCFO-1233zd, and a combination thereof.

5. The method of claim 3, wherein the rodenticide composition comprises 2-chloropentafluoropropene in an amount from about 10% by weight of the composition to about 90% by weight of the composition, and the at least one solvent in an amount from about 90% by weight of the composition to about 10% by weight of the composition.

6. The method of claim 3, wherein the rodenticide composition comprises 2-chloropentafluoropropene in an amount from about 90% by weight of the composition to about 51% by weight of the composition.

7. The method of claim 1, wherein the gaseous rodenticide composition comprises at least one other active ingredient selected from the group consisting of carbon disulfide, aluminum phosphide, magnesium phosphide, and chloropicrin.

8. The method of claim 1, wherein the step of preparing comprises:
combining 2-chloropentafluoropropene with at least one second component to form a rodenticide composition.

9. The method of claim 8, wherein the at least one second component is selected from the group consisting of a solvent, an additional active ingredient, or a combination thereof.

10. The method of claim 9, wherein the solvent is selected from the group consisting of HFO-1234yf, HFO-1234ze, cis-HCFO-1233zd, trans-HCFO-1233zd, and a combination thereof.

11. The method of claim 9, wherein the additional active ingredient is selected from the group consisting of carbon disulfide, aluminum phosphide, magnesium phosphide, and chloropicrin.

12. The method of claim 8, wherein the step of combining is carried out at a temperature at or above the boiling point of the rodenticide composition.

13. The method of claim 8, wherein the step of combining is carried out at a temperature below the boiling point of the rodenticide composition, and the rodenticide composition is heated to a temperature at or above the boiling point of the rodenticide composition to form the gaseous rodenticide composition.

14. The method of claim 1, wherein the step of providing is carried out at an environmental temperature from about 10° C. to about 30° C.

15. A rodenticide composition comprising:
2-chloropentafluoropropene and at least one second component.

16. The rodenticide composition of claim 15, wherein the at least one second component is selected from the group consisting of a solvent, an additional active ingredient, or a combination thereof.

17. The rodenticide composition of claim 16, wherein the solvent is selected from the group consisting of HFO-1234yf, HFO-1234ze, cis-HCFO-1233zd, trans-HCFO-1233zd, and a combination thereof.

18. The rodenticide composition of claim 16, wherein the additional active ingredient is selected from the group consisting of carbon disulfide, aluminum phosphide, magnesium phosphide, and chloropicrin.

19. The rodenticide composition of claim 15, wherein the rodenticide composition comprises 2-chloropentafluoropropene in an amount from about 10% by weight of the composition to about 90% by weight of the composition.

20. The rodenticide composition of claim 15, wherein the rodenticide composition comprises 2-chloropentafluoropropene in an amount from about 90% by weight of the composition to about 51% by weight of the composition.
